(19) United States
(12) Patent Application Publication
(10) Pub. No.: US 2023/0141769 A1
(43) Pub. Date: May 11, 2023

(54) WORKPIECE SWITCHING JIG AND CUTTING SYSTEM

(71) Applicant: FANUC CORPORATION, Yamanashi (JP)

(72) Inventor: Kazuyoshi MATAKE, Yamanashi (JP)

(21) Appl. No.: 17/918,803

(22) PCT Filed: Apr. 15, 2021
(86) PCT No.: PCT/JP2021/015599

§ 371 Date: Oct. 13, 2022

(30) Foreign Application Priority Data
Apr. 20, 2020 (JP) 2020-074959

(51) Int. Cl. B26D 7/18; B23H 7/02; B25J 11/00

(52) U.S. Cl. CPC B26D 7/18; B23H 7/02; B25J 11/0055

(57) ABSTRACT

An object is to collect a cut-off portion cut off from a workpiece with a simple structure. A workpiece switching jig 20 according to one aspect of the present disclosure is attachable to and detachable from a cutting machine 30 and holds a workpiece W to be cut by the cutting machine 30. The workpiece switching jig 20 includes a jig main body 21 configured to hold the workpiece W, a cut-off portion basket 25 configured to receive a cut-off portion W2 cut off from the workpiece W by the cutting machine 30, and an arm 23 configured to support the cut-off portion basket 25 with respect to the jig main body 21.

### FIELD

Embodiments described herein relate generally to a workpiece switching jig and a cutting system.

### BACKGROUND

A wire electric discharge machine is known as one of the cutting machines for cutting a workpiece. In a wire electric discharge machine, a workpiece (workpiece to be processed) is placed in a work tank filled with a working fluid, and the workpiece can be cut by utilizing the discharge phenomenon that occurs between a conductive wire electrode and the workpiece.

If a cut-off portion cut off from the workpiece by the wire electric discharge machine is dropped into the work tank, when an arm is operated to move the wire, the arm interferes with the cut-off portion dropped into the work tank, and the mechanism including the arm may be damaged. Therefore, various techniques have been proposed to prevent the cut-off portion from dropping into the work tank. For example, Patent Literature 1 discloses a method in which a robot holds the workpiece and the cut-off portion. In this method, it is necessary to make the movement of the robot follow the movement of the wire, which makes the control complicated, and may be a factor that makes the processing accuracy less than the processing accuracy of the wire electric discharge machine. In addition, the robot may come into contact with a structure of the wire electric discharge machine during processing and damage the structure. Limiting the operating range of the robot can reduce the possibility that the robot comes into contact with the wire electric discharge machine, but it also limits the operating range of the wire, and thus reduces the processing range.

### CITATION LIST

### Patent Literature

Patent Literature 1: Japanese Unexamined Patent Application Publication No. 61-8224

### SUMMARY OF INVENTION

### Technical Problem

Therefore, it is desired to easily collect the cut-off portion cut off from the workpiece.

### Solution to Problem

A workpiece switching jig according to one aspect of the present disclosure is attachable to and detachable from a cutting machine and holds a workpiece to be cut by the cutting machine. The workpiece switching jig includes a jig main body configured to hold the workpiece, a cut-off portion basket configured to receive a cut-off portion cut from the workpiece by the cutting machine, and an arm configured to support the cut-off portion basket with respect to the jig main body.

### Advantageous Effects of Invention

According to this aspect, the cut-off portion can be easily collected for each cutting process.

### BRIEF DESCRIPTION OF THE DRAWINGS

FIG. 1 is a side view showing a configuration of a cutting system according to the present embodiment.

FIG. 2 is a plan view of the cutting system shown in FIG. 1.

FIG. 3 is a view shows a table of a wire electric discharge machine shown in FIG. 1.

FIG. 4 is a perspective view showing an example of a workpiece switching jig shown in FIG. 2.

FIG. 5 is a plan view of the workpiece switching jig shown in FIG. 3.

FIG. 6 is an end view of an A-A′ section showing an example of a cut-off portion basket shown in FIG. 5.

FIG. 7 is an end view of the A-A′ section showing another example of the cut-off portion basket shown in FIG. 5.

FIG. 8 is an end view of the A-A′ section showing another example of the cut-off portion basket shown in FIG. 5.

FIG. 9 is an end view of a B-B′ section showing an example of the cut-off portion basket shown in FIG. 5.

FIG. 10 is an end view of the B-B′ section showing another example of the cut-off portion basket shown in FIG. 5.

FIG. 11 is a perspective view showing another example of the cut-off portion basket shown in FIG. 5.

FIG. 12 is a view showing an example of a structure for adjusting the relative position of the cut-off portion basket with respect to a jig main body shown in FIG. 3.

FIG. 13 is a view showing another example of the structure for adjusting the relative position of the cut-off portion basket with respect to the jig main body shown in FIG. 3.

FIG. 14 is a view showing another example of the structure for adjusting the relative position of the cut-off portion basket with respect to the jig main body shown in FIG. 3.

### DETAILED DESCRIPTION

Hereinafter, a cutting system according to the present embodiment will be described with reference to the drawings. In the following description, constituent elements having substantially the same function and configuration are denoted by the same reference numeral, and a repetitive description will be given only where necessary.

(Configuration of Cutting System 10)

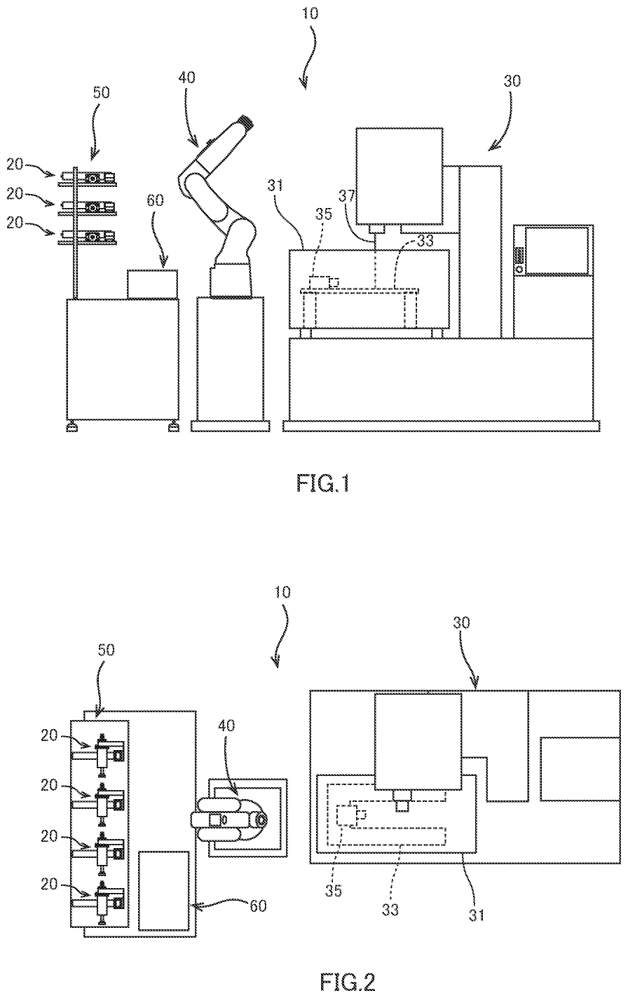

As shown in FIGS. 1 and 2, a cutting system 10 according to the present embodiment includes a wire electric discharge machine 30 that cuts a workpiece W, a storage shelf 50 that stores a plurality of workpiece switching jigs 20 in a state of holding the workpiece W, a robot arm mechanism 40 that transports the workpiece switching jigs 20 between the storage shelf 50 and the wire electric discharge machine 30, and a disposal bucket 60 in which a cut-off portion W2 cut off from the workpiece W is discarded. Typically, the robot arm mechanism 40 is arranged between the storage shelf 50 and the wire electric discharge machine 30, and the disposal bucket 60 is arranged on the transport path of the workpiece switching jigs 20 between the robot arm mechanism 40 and the storage shelf 50.

The wire electric discharge machine 30 can be replaced with another cutting machine such as a saw blade cutting machine having a function of cutting the workpiece W. Further, the robot arm mechanism 40 can be replaced with another type of transport loader mechanism having a function of transporting the workpiece switching jigs 20.

(Cutting Procedure Using Cutting System 10)

The cutting procedure of the workpiece W using the cutting system 10 according to the present embodiment is as follows. The storage shelf 50 stores a plurality of workpiece switching jigs 20 in a state of holding the workpiece W before cutting.

First, the robot arm mechanism 40 holds a workpiece switching jig 20 stored in the storage shelf 50, transports the workpiece switching jig 20 into a work tank 31 of the wire electric discharge machine 30, and attaches the workpiece switching jig 20 to a chuck member 35 of a table 33 in the work tank 31 (see FIG. 3). When the workpiece switching jig 20 is attached to the chuck member 35, the wire electric discharge machine 30 starts cutting the workpiece W. Upon completion of the cutting by the wire electric discharge machine 30, the workpiece switching jig 20 in a state of holding a workpiece W1 after cutting and a cut-off portion W2 cut off from the workpiece W before cutting is removed from the chuck member 35 of the table 33 in the work tank 31 and transported to and stored in the storage shelf 50 by the robot arm mechanism 40.

The cut-off portion W2 held by the workpiece switching jig 20 is released to the disposal bucket 60 by a disposal operation performed by the robot arm mechanism 40 above the disposal bucket 60 during transport of the workpiece switching jig 20 from the wire electric discharge machine 30 to the storage shelf 50. Since the disposal bucket 60 is arranged on the transport path of the workpiece switching jig 20 between the wire electric discharge machine 30 and the storage shelf 50 which stores the workpiece switching jig 20 after cutting, the time required for discarding the cut-off portion W2 held by the workpiece switching jig 20 can be shortened, and the reduction in work efficiency can be suppressed. Further, since the worker does not need to collect the cut-off portion W2 from the workpiece switching jig 20 stored in the storage shelf 50, the cutting system 10 can be operated unattended without imposing a workload on the worker.

Also, since the workpiece switching jig 20 has a function of holding the workpiece W1 after cutting and the cut-off portion W2 cut off from the workpiece W before cutting, the cut-off portion W2 can be collected together with the workpiece switching jig 20 holding the cut-off portion W2 each time cutting is performed. Since the cut-off portion W2 does not remain in the work tank 31, the risk that the cut-off portion W2 interferes with the operation of the wire electric discharge machine 30 can be reduced. The collection operation of the workpiece switching jig 20 by the robot arm mechanism 40 or the worker (or the collection operation of the workpiece W1 after cutting corresponding to the collection operation of the workpiece switching jig 20) is included in the cutting procedure of the conventional cutting system, and does not significantly lower the work efficiency of the conventional cutting process since addition of a new step for collecting the cut-off portion W2 is not required.

(Description of Workpiece Switching Jig 20)

Hereinafter, the workpiece switching jig 20 will be described in detail.

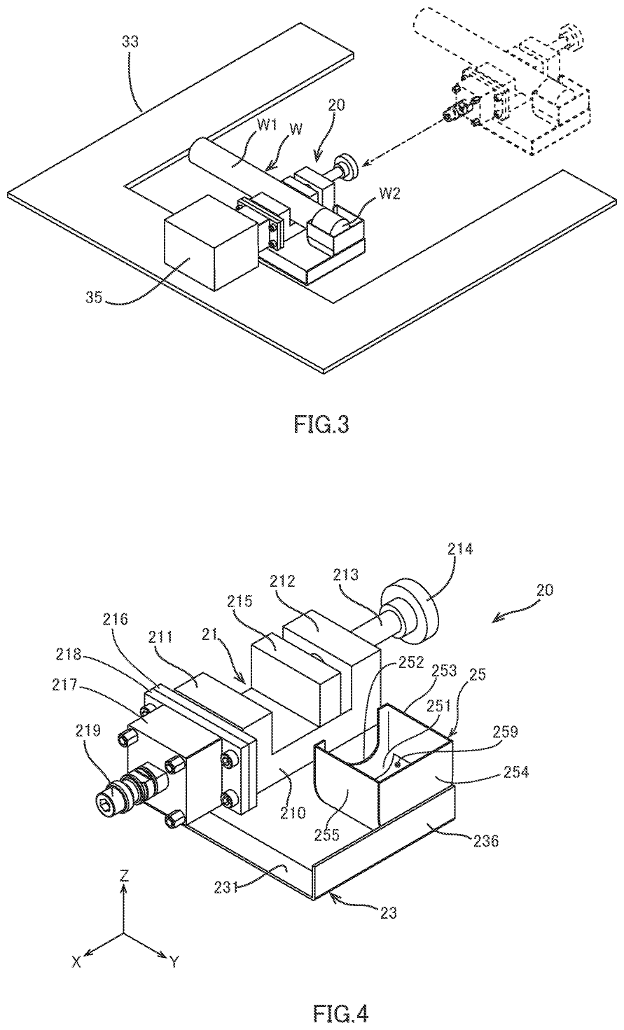

As shown in FIGS. 4 and 5, the workpiece switching jig 20 has a jig main body 21 that holds a workpiece W before cutting, a cut-off portion basket 25 that receives a cut-off portion W2 cut off from the workpiece W, and an arm 23 that supports the cut-off portion basket 25 with respect to the jig main body 21.

In the jig main body 21, a fixture for attaching the workpiece switching jig 20 to the chuck member 35 of the base portion 33 of the wire electric discharge machine 30 is detachably attached to a vise that holds and fixes a workpiece W between two members.

Specifically, the jig main body 21 has a rectangular plate-shaped main body base 210. Hereinafter, an axis parallel to the longitudinal direction of the main body base 210 is referred to as an X-axis, an axis parallel to the lateral direction of the main body base 210 is referred to as a Y-axis, and an axis parallel to the thickness (height) direction of the main body base 210 is referred to as a Z-axis.

A block-shaped fixed portion 211 is provided on the surface of the main body base 210 on one end side, and a block-shaped support portion 212 is provided on the surface on the other end side. The fixed portion 211 and the support portion 212 are spaced apart along the X-axis. Actually, the main body base 210, the fixed portion 211, and the support portion 212 are integrally molded.

The support portion 212 is provided with a screw hole penetrating in a direction parallel to the X-axis. A rod 213 is inserted and screwed into the screw hole. A handle 214 is provided at the rear end of the rod 213, and a block-shaped movable portion 215 is connected to the front end of the rod 213. The movable portion 215 is supported movably along the X-axis on the main body base 210. By arranging the workpiece W between the fixed portion 211 and the movable portion 215 and rotating the handle 214 so that the movable portion 211 approaches the fixed portion 215, the worker can sandwich and fix the workpiece W between the fixed portion 211 and the movable portion 215. The main body base 210, the fixed portion 211, the support portion 212, the rod 213, the handle 214, and the movable portion 215 constitute the vise.

A flange 216 is provided on one end surface of the main body base 210, and an attachment portion is detachably connected via the flange 216. The attachment portion has a block-shaped attachment base 217. The fixture 219 is supported on one side surface of the attachment base 217. A flange 218 is provided on the other side surface of the attachment base 217 opposite to the side surface on which the fixture 219 is provided. The attachment portion is connected to the main body base 210 by fastening its flange 218 to the flange 216 of the main body base 210 with a bolt or the like in a state where the flange 218 is joined to the flange 216. By configuring the attachment portion provided with the fixture 219 to be attachable to and detachable from the vise composed of the main body base 210 and the like, only the attachment portion needs to be replaced even when the chuck member 35 to which the workpiece switching jig 20 is connected is changed, and the versatility of the workpiece switching jig 20 can be improved.

The arm 23 has an L-shaped appearance. The cut-off portion basket 25 is connected to the front end of the arm 23, and the rear end of the arm 23 is attached to the jig main body 21. The arm 23 is attached to the jig main body 21 such that a first arm portion 231 constituting the arm 23 is parallel to the Y-axis, a second arm portion 236 constituting the arm 23 is parallel to the X-axis, and the cut-off portion basket 25 at the front end of the arm 23 is arranged at a position where the cut-off portion basket 25 can receive the cut-off portion W2 cut off from the workpiece W. For example, when the workpiece W is a round bar as in the present embodiment, the cut-off portion basket 25 is arranged between the fixed portion 211 and the movable portion 215 of the jig main body 21 by the arm 23.

The shape and size of the arm 23 and the attachment position of the arm 23 to the jig main body 21 can be discretionarily determined as long as a gap for passing a wire 37 of the wire electric discharge machine 30 can be provided between the jig main body 21 and the cut-off portion basket 25 and the cut-off portion basket 25 can be arranged at a position where the cut-off portion basket 25 can receive the cut-off portion W2 cut off from the workpiece W. Therefore, the external shape of the arm 23 is not limited to an L-shape, and may be bent, curved, or any combination of these shapes.

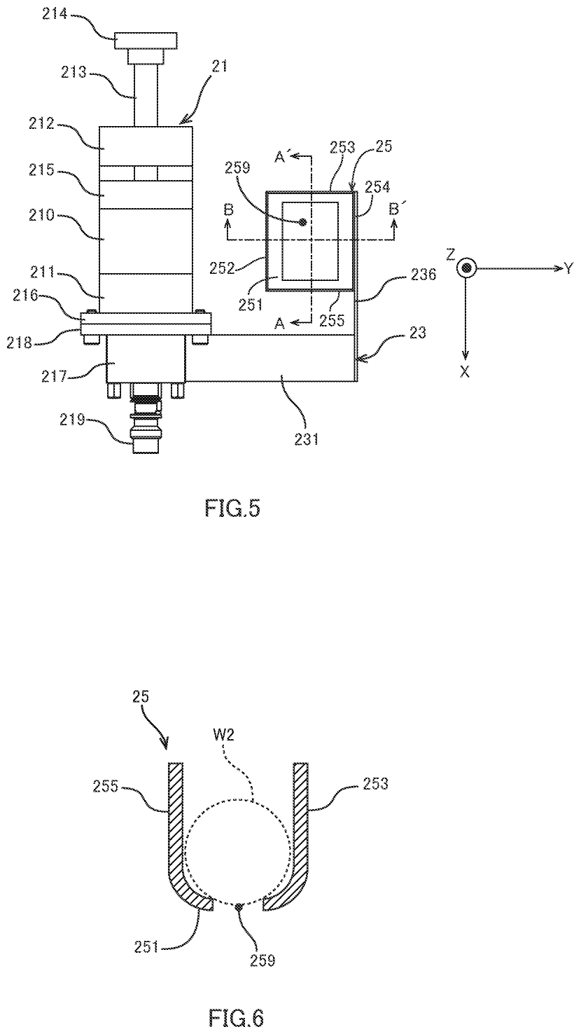

The cut-off portion basket 25 is shaped like a box with an open top. A space for receiving the cut-off portion W2 is demarcated by a bottom plate and a side plate constituting the box. The cut-off portion basket 25 has an inner surface shape consistent with the cut-off portion W2. For example, in the case where a round bar as the workpiece W is fixed to the jig main body 21 so as to be parallel to the Y-axis (see FIG. 3), the cut-off portion basket 25 is composed of four side plates 252, 253, 254, and 255 so that a space for receiving the cut-off portion W2 is rectangular in plan view, as shown in FIG. 5. As shown in FIG. 6, the bottom plate 251 is configured to curve convexly along the X-axis.

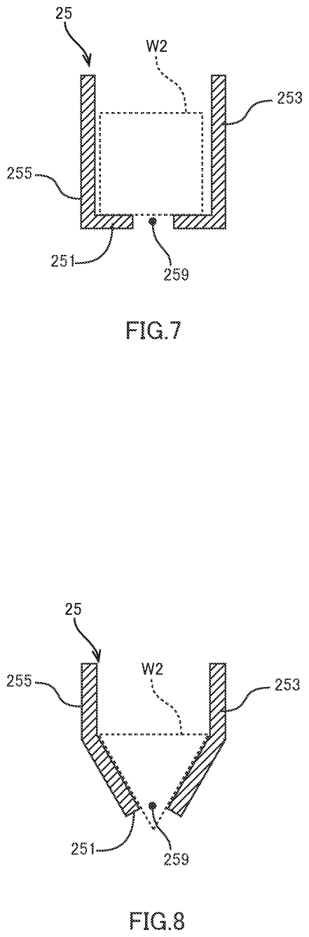

The shape of the cut-off portion basket 25 is not limited to the above as long as it is consistent with the cut-off portion W2. For example, when the workpiece W is a squire bar having a rectangular cross section, the bottom plate 251 is flat as shown in FIG. 7. Further, when the workpiece W is a bar having a triangular cross section, the bottom plate 251 is configured to project in a V-shape as shown in FIG. 8. As a result, the cut-off portion W2 cut off from the workpiece W can be stabilized in the cut-off portion basket 25, and the possibility of dropping from the workpiece switching jig 20 during transport can be reduced.

The bottom plate 251 of the cut-off portion basket 25 has an opening 259 for draining the working fluid filled in the work tank 31 of the wire electric discharge machine 30. Typically, the opening 259 is one opening, but may include a plurality of openings or be reticulated. The shape of the opening 259 is typically rectangular, but may be another shape such as a circle. Of course, when a cutting machine that cuts the workpiece W without submerging the workpiece W in the work tank 31 filled with the working fluid is used, the opening 259 is not necessarily required.

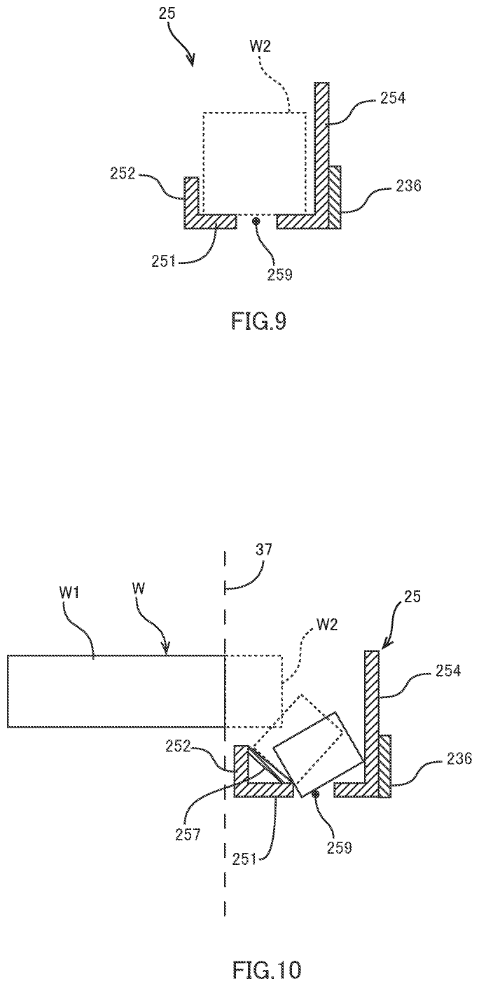

In the cut-off portion basket 25, of the side plate, the side plate portion on the side close to the jig main body 21 is lower than the other side plate portions. For example, in the case of the cut-off portion basket 25 having a rectangular shape in plan view as shown in FIG. 5, of the four side plates 252, 253, 254, and 255, one side plate 252 on the side close to the jig main body 21 is lower than the other side plates 253, 254, and 255 as shown in FIG. 9. Accordingly, the workpiece W can be brought closer to the bottom plate 251, the possibility that the cut-off portion W2 falls outside the cut-off portion basket 25 can be reduced. In particular, when cutting is performed with the workpiece W submerged in the work tank 31 filled with the working fluid, the cut-off portion W2 cut off from the workpiece W may not fall directly below, so that the side plate is partially lowered to bring the workpiece W as close as possible to the bottom plate 251 is very effective in reliably accommodating the cut-off portion W2 in the cut-off portion basket 25. Further, by making the other side plate portions higher, even if the cut-off portion W2 cut off from the workpiece W flies in all directions in reaction to cutting, the cut-off portion W2 can be prevented from falling outside the cut-off portion basket 25.

As shown in FIG. 10, the cut-off portion basket 25 may have an inclined plate 257 that guides the cut-off portion W2 to the bottom plate 251. The inclined plate 257 is arranged so as to be inclined from the edge of one side plate 252 close to the jig main body 21 of the four side plates 252, 253, 254, and 255 toward the bottom plate 251. Since the cut-off portion W2 cut off from the workpiece W can be slid down along the inclined plate 257 toward the bottom plate 251 at a slow speed, the possibility that the cut-off portion W2 falls directly to the outside of the cut-off portion basket 25 and the possibility that the cut-off portion W2 bounces on the bottom plate 251 and goes out to the outside of the cut-off portion basket 25 can be reduced in comparison with the configuration without the inclined plate 257. In addition, since the cut-off portion W2 reaches the bottom plate 251 in an inclined posture along the inclined plate 257, a part of the cut-off portion W2, such as a corner of the cut-off portion W2 can be engaged with the opening 259 formed in the bottom plate 251, and the cut-off portion W2 can be more stably accommodated in the cut-off portion basket 25.

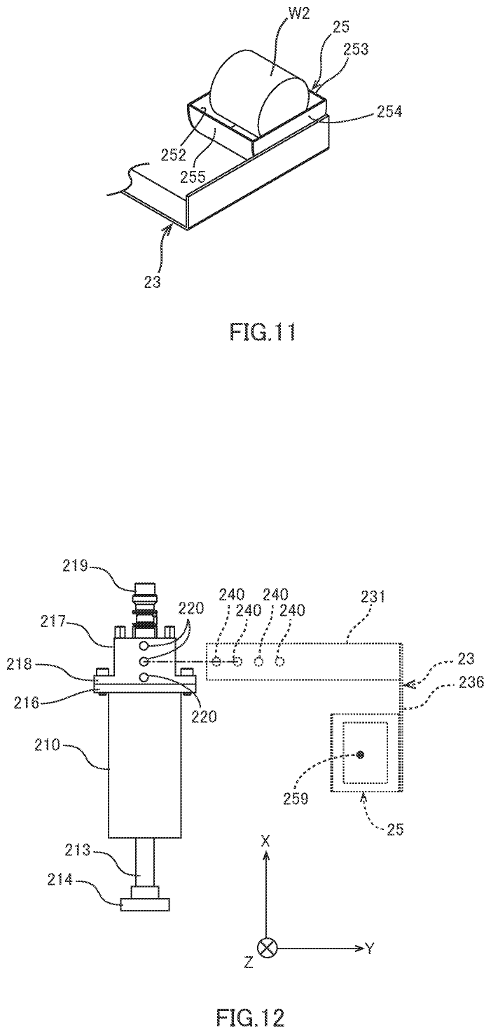

Also, as shown in FIG. 11, the height of the entire side plate may be made smaller than the thickness of the cut-off portion W2 from the viewpoint of making it easier to drop the cut-off portion W2 from the cut-off portion basket 25 during the disposal operation of the cut-off portion W2 held by the workpiece switching jig 20 by the robot arm mechanism 40. Further, if the cut-off portion W2 has a circular cross section as in the present embodiment, the cut-off portion basket 25 can be configured to have the side plate so as to have a cross-sectional shape that widens from the bottom to the open top, such as a V-shape or semicircle, in order to facilitate rolling of the cut-off portion W2 along the side plate.

In addition, the cut-off portion basket 25 may be detachably attached to the arm 23. The versatility of the workpiece switching jig 20 can be improved by preparing multiple types of cut-off portion baskets 25 having different shapes and sizes, selecting a cut-off portion basket 25 corresponding to the workpiece W, and attaching the cut-off portion basket 25 to the arm 23.

In the workpiece switching jig 20 according to the present embodiment, the relative position of the cut-off portion basket 25 with respect to the jig main body 21 can be adjusted. As a structure for achieving this, a structure in which the attachment position of the arm 23 with respect to the jig main body 21 can be changed can be employed.

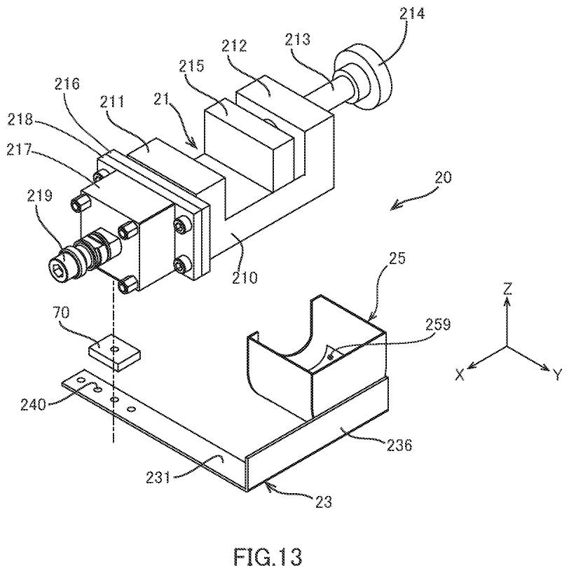

As shown in FIG. 12, the jig main body 21 has a plurality of screw holes 220 for attaching the arm 23 so that the attachment position of the arm 23 with respect to the jig main body 21 can be changed. The screw holes 220 are provided on the back surface of the jig main body 21 so as to be dispersed along the X-axis and the Y-axis. The first arm portion 231 on the rear end side of the arm 23 is provided with a plurality of through holes 240. The worker can attach the arm 23 to the jig main body 21 by screwing in a state where a through hole 240 selected from the through holes 240 provided in the arm 23 is aligned with a screw hole 220 selected from the screw holes 220 provided in the jig main body 21. By changing at least one of the screw hole 220 of the jig main body 21 and the through hole 240 of the arm 23, the position of the cut-off portion basket 25 with respect to the jig main body 21 can be adjusted in the X-axis direction and the Y-axis direction. Here, the X-axis direction corresponds to a direction in which the cut-off portion basket 25 approaches/moves away from the jig main body 21, and the Y-axis direction corresponds to a direction perpendicular to the direction in which the cut-off portion basket 25 approaches/moves way from the jig main body 21.

In order to adjust the position of the cut-off portion basket 25 with respect to the jig main body 21 in the X-axis direction and the Y-axis direction, a plurality of attachment structures (screw holes or through holes) may be provided in at least one of the jig main body 21 and the arm 23.

As shown in FIG. 13, when it is desired to adjust the position of the cut-off portion basket 25 with respect to the jig main body 21 in the Z-axis direction, a spacer member 70 having a thickness corresponding to the adjustment width may be interposed between the jig main body 21 and the arm 23. As described with reference to FIG. 12, it is also possible to have a structure for adjusting the position of the cut-off portion basket 25 with respect to the jig main body 21 in the Z-axis direction by changing the attachment position of the arm 23 with respect to the jig main body 21. In this case, for example, a plurality of screw holes are provided in a side surface of the jig main body 21, the arm 23 is composed of three arm portions parallel to the three orthogonal axes, respectively, and a plurality of through holes are provided in the arm portion along the Z-axis.

As long as the arm 23 can be attached to the jig main body 21, the attachment structure is not limited to screws, and any structure such as a bolt-nut structure or a fitting structure can be employed.

In the above-described configuration, the relative position of the cut-off portion basket 25 with respect to the jig main body 21 is adjusted by changing the attachment position of the arm 23 with respect to the jig main body 21 and by interposing the spacer member 70 between the jig main body 21 and the arm 23; however, the arm 23 may have a structure for adjusting the position of the cut-off portion basket 25 with respect to the jig main body 21.

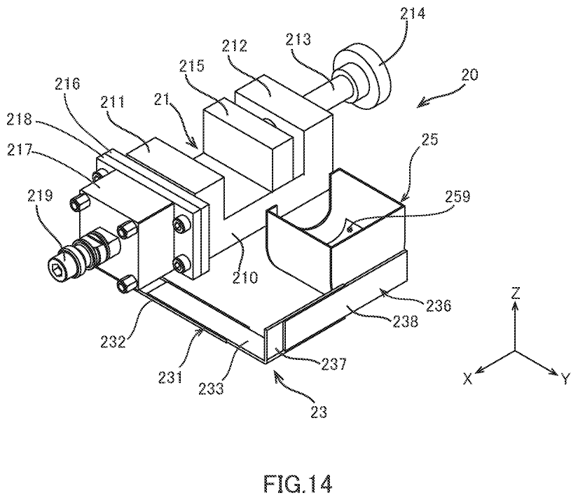

As shown in FIG. 14, the first and second arm portions 231 and 236 constituting the arm 23 each have an extensible mechanism. As the extensible mechanism, any mechanism such as a mechanism utilizing a slide bar, a ball screw mechanism, or a slide rail mechanism, can be used. Here, a slide rail mechanism will be described as an example of the extensible mechanism. The first arm portion 231 has a first fixed rail 232 attached to the jig main body 21 at its rear end portion and a first moving rail 233 slidably supported on the first fixed rail 232. The second arm portion 236 has a second fixed rail 237 connected to the first moving rail 233 and a second moving rail 238 slidably supported on the second fixed rail 237 and provided with the cut-off portion basket 25 at its front end. According to the above configuration, the position of the cut-off portion basket 25 with respect to the jig main body 21 can be adjusted in the Y-axis direction by changing the extension length of the first arm portion 231 arranged along the Y-axis. Similarly, the position of the cut-off portion basket 25 with respect to the jig main body 21 can be adjusted in the X-axis direction by changing the extension length of the second arm portion 236 arranged along the X-axis. When the arm 23 itself has a structure capable of adjusting the position of the cut-off portion basket 25 with respect to the jig main body 21, it is advantageous from the viewpoint of ease of adjustment to configure the arm 23 in an L-shape and to attach the arm 23 to the jig main body 21 so that the first arm portion 231 and the second arm portion 236 constituting the arm 23 are parallel to the Y-axis and the X-axis, respectively.

If it is desired to adjust the position of the cut-off portion basket 25 with respect to the jig main body 21 in the Z-axis direction, the arm 23 may be composed of three arm portions arranged along the three orthogonal axes, respectively, and the arm portion arranged along the Z-axis may be extended or contracted. The attachment structure of the arm 23 to the jig main body 21 described with reference to FIGS. 12 and 13 may be combined with the extensible structure of each arm portion 231, 236 constituting the arm 23 described with reference to FIG. 14. Accordingly, by interposing the spacer member 70 between the arm 23 and the jig main body 21 illustrated in FIG. 14, the position of the cut-off portion basket 25 with respect to the jig main body 21 can be adjusted in the Z-axis direction.

The arm 23 may be composed of multiple types of small components having a coupling structure. By changing the combination or the number of components constituting the arm 23, the shape and size of the arm 23 can be discretionarily changed, and thereby the relative position of the cut-off portion basket 25 with respect to the jig main body 21 can be adjusted.

While some embodiments of the present invention have been described, these embodiments have been presented as examples, and are not intended to limit the scope of the invention. These embodiments can be implemented in various other forms, and various omissions, replacements, and changes can be made without departing from the spirit of the invention. These embodiments and their modifications are included in the scope and spirit of the invention and are included in the scope of the claimed inventions and their equivalents.

### EXPLANATION OF REFERENCE NUMERALS

20: workpiece switching jig, 21: jig main body, 210: main body base, 211: fixed portion, 212: support portion, 213: rod, 214: handle, 215: movable portion, 216, 218: flange, 217: attachment base, 219: fixture, 23: arm, 231: first arm portion, 236: second arm portion, 25. cut-off portion basket, 251: bottom plate, 252, 253, 254, 255: side plate, 259: opening

1. A workpiece switching jig attachable to and detachable from a cutting machine and configured to hold a workpiece to be cut by the cutting machine, the workpiece switching jig comprising:
a jig main body configured to hold the workpiece;
a cut-off portion basket configured to receive a cut-off portion cut off from the workpiece by the cutting machine; and
an arm configured to support the cut-off portion basket with respect to the jig main body.

2. The workpiece switching jig according to claim 1, wherein the arm is bent or curved to position the cut-off portion basket with respect to the jig main body with a gap therebetween.

3. The workpiece switching jig according to claim 1, wherein a relative position of the cut-off portion basket with respect to the jig main body is adjustable.

4. The workpiece switching jig according to claim 3, wherein the arm has a structure to extend and contract in a direction in which the cut-off portion basket approaches/moves away from the jig main body.

5. The workpiece switching jig according to claim 3, wherein the arm has a structure to extend and contract in a direction perpendicular to a direction in which the cut-off portion basket approaches/moves away from the jig main body.

6. The workpiece switching jig according to claim 3, wherein the jig main body includes a plurality of attachment structures for attaching the arm, and the arm is attached to an attachment structure selected from the attachment structures in order to adjust the relative position of the cut-off portion basket with respect to the jig main body.

7. The workpiece switching jig according to claim 3, wherein a spacer member is interposed between the jig main body and the arm.

8. The workpiece switching jig according to claim 1, wherein the cut-off portion basket includes an inclined plate for moving the cut-off portion cut off from the workpiece in a direction away from the jig main body.

9. The workpiece switching jig according to claim 1, wherein the cut-off portion basket includes a bottom plate and a side plate to demarcate a space for receiving the cut-off portion and, of the side place, a side plate portion close to the jig main body is lower than other side plate portions.

10. The workpiece switching jig according to claim 1, wherein the cut-off portion basket includes a bottom plate and a side plate to demarcate a space for receiving the cut-off portion, and an opening is formed in the bottom plate.

11. The workpiece switching jig according to claim 1, wherein the cut-off portion basket has an inner surface shape that is consistent with a cross-sectional shape of the workpiece.

12. The workpiece switching jig according to claim 1, wherein the cut-off portion basket includes a bottom plate and a side plate to demarcate a space for receiving the cut-off portion, and a height of the side plate is smaller than a thickness of the cut-off portion.

13. A cutting system comprising:
a cutting machine configured to cut a workpiece; and
a workpiece switching jig attachable to and detachable from a table of the cutting machine and configured to hold the workpiece, wherein
the workpiece switching jig includes:
a jig main body configured to hold the workpiece;
a cut-off portion basket configured to receive a cut-off portion cut off from the workpiece by the cutting machine; and
an arm configured to support the cut-off portion basket on the cutting machine.

14. The cutting system according to claim 13, further comprising:
a storage shelf configured to store the workpiece after cutting by the cutting machine in a state where the workpiece is held by the workpiece switching jig; and
a transport mechanism configured to transport the workpiece switching jig between the cutting machine and the storage shelf, wherein
a disposal bucket for collecting the cut-off portion received by the cut-off portion basket is arranged on a transport path from the cutting machine to the storage shelf.

15. The cutting system according to claim 14, wherein the transport mechanism is an articulated robot arm mechanism.
